(19) United States
(12) Patent Application Publication
(10) Pub. No.: US 2020/0341444 A1
(43) Pub. Date: Oct. 29, 2020

(54) SYSTEMS AND METHODS FOR WIRELESS MONITORING AND CONTROL OF MACHINERY

(71) Applicants: Rob Dusseault, Chemainus (CA); Tim Burnham, Manaimo (CA); Gordon Graham Schnare, Vernon (CA); Kevin Fisk, Armstrong (CA); Troy Watts, Vernon (CA)

(72) Inventors: Rob Dusseault, Chemainus (CA); Tim Burnham, Manaimo (CA); Gordon Graham Schnare, Vernon (CA); Kevin Fisk, Armstrong (CA); Troy Watts, Vernon (CA)

(21) Appl. No.: 16/858,389

(22) Filed: Apr. 24, 2020

Related U.S. Application Data
(60) Provisional application No. 62/838,113, filed on Apr. 24, 2019.

(51) Int. Cl. G05B 19/05; G05B 17/02; G06F 17/14; H04W 72/04; H04W 24/10; H01C 7/00; H04R 1/40

(52) U.S. Cl. CPC G05B 19/058; G05B 17/02; G06F 17/14; G05B 2219/23067; H04W 24/10; H01C 7/008; H04R 1/406; H04W 72/0453

(57) ABSTRACT

Disclosed is a system for monitoring and control of machinery. In embodiments, a maintenance sensor measures data from a machine and processes the data prior to its wireless transmission to a wireless zone kit, which, in turn, sends the data to a controller. Processing of measured data at a wireless maintenance sensor can include generating a digital energy model, that provides sufficient data to the control system to allow decisions and actions to be taken by an operator, while reducing power consumption and extending a lifetime of the sensor and/or a power source of the sensor. The processing elements may include Fourier analysis of the data. A method of operation of a system for monitoring and controlling a machine is also disclosed.

### CROSS REFERENCE TO RELATED APPLICATIONS

This application claims priority to U.S. Provisional Patent Application to Rob Dusseault entitled “SYSTEMS AND METHODS FOR WIRELESS MONITORING AND CONTROL OF MACHINERY,” serial number 62838113, filed Apr. 24, 2019, the disclosures of which are hereby incorporated entirely herein by reference.

### BACKGROUND OF THE INVENTION

### Technical Field

The present application relates to systems and methods for wireless monitoring, and control of machinery, and particular implementations provide wireless monitoring and control of industrial machinery that includes a rotating shaft.

### BRIEF SUMMARY

An industrial facility can include a) industrial machinery, and b) a control system that can oversee a large number of machines and other pieces of equipment. The control system can gather input from a variety of devices that can include instruments, sensors, and sensing elements of sensors. The control system typically employs one or more computer systems communicably coupled to the devices, and to each other, by one or more data networks. Network communication can be wired or wireless. The computer systems can include a human-machine interface (HMI). The devices can include various types of sensors, for example vibration sensors, pressure gauges, pressure sensors, temperature gauges, and temperature sensors. The devices can include actuators, breakers, or other elements besides sensors. A device can possess a unique identity (for example, an identification code). A device can be associated with a description of the device.

A device can include a wireless maintenance sensor. A wireless maintenance sensor is a sensor that can transmit data wirelessly from the sensor to another sensor or device. Data wirelessly transmitted by a wireless maintenance sensor can include data useful for maintenance of the device. Examples of data useful for maintenance of a device that can be sensed by a wireless maintenance sensor, and wirelessly transmitted to another sensor or device, can include vibration data, temperature data, pressure data, and the like.

Wireless maintenance sensors can include a power source. For example, a wireless maintenance sensor can include a lithium battery. Wireless transmission of data by a wireless maintenance sensor can be a significant element of the power budget of the wireless maintenance sensor. It can be beneficial to reduce the power used by a wireless maintenance sensor to increase the life of the power source, and/or to reduce the frequency at which the power source needs to be replaced.

Reducing the power used by a wireless maintenance sensor can include reducing the volume of data transmitted by the wireless maintenance sensor. In some implementations, data transmitted by the wireless maintenance sensor is reduced to a handful of bytes of data per transmission. Examples of data wirelessly transmitted by a wireless maintenance sensor can include temperature data (such as a temperature reading) and/or pressure data (such as a pressure reading).

A wireless maintenance sensor can wirelessly transmit vibration data to another device or sensor. The volume of vibration data useful for performing a comprehensive vibrational data analysis can be significantly larger than the volume of data useful for monitoring temperature and/or pressure, for example. Wirelessly transmitting vibration data can consume a significant amount of power from a power source of a wireless maintenance sensor, for example. In one example implementation, vibration data can include more than one thousand data values per sample at a sampling interval of 32 ms, which can translate to a data transmission rate of 31.25 kB/s (assuming the data is 8-bit data and each data value can be represented by a single byte).

A shortcoming of existing technology can be that wireless transmission of data (for example vibration data for analysis such as comprehensive vibrational analysis) can be a drain on the power source of the wireless maintenance sensor responsible for the wireless transmission. It can be desirable to reduce the volume of data wirelessly transmitted by the wireless maintenance sensor. It can be desirable to reduce the volume of data wirelessly transmitted by the wireless maintenance sensor per sample, and/or to increase the sampling interval. In so doing, a lifetime of the wireless maintenance sensor (or at least a lifetime of a power source of a wireless maintenance sensor) can be increased. In some implementations, it can be desirable for the lifetime of the wireless maintenance sensor to exceed twelve months.

Existing technology can include systems and methods for reducing power consumed by sensors and/or devices that record and transmit data wirelessly. For example, U.S. Pat. No. 7,424,403 describes a low-power vibration sensor and wireless transmission system. U.S. Patent Application US2012/0319866 describes a wireless sensor device and a method for wirelessly communicating a sensed physical parameter. Reducing the power consumed by sensors and/or devices can include a) reducing the volume of data transmitted wirelessly, and b) operating the sensor for only a short period when it uses battery power, followed by longer periods with no consumption. A benefit can be reduced battery consumption, increased longevity of the battery, and/or increased longevity of the sensor. Balancing battery longevity of sensors with wireless transmission of data suitable for operation and/or maintenance of industrial machinery can be technically challenging, especially in the context of industrial standards and regulations. In some implementations, a challenge can include balancing battery and/or sensor longevity with providing sufficient data to an HMI of the control system to allow decisions and actions to be taken by an operator and/or maintenance personnel.

A vibration signature of an apparatus (for example, an industrial machine) is the characteristic pattern of vibration the apparatus generates during operation. An example of an apparatus that can generate a complex vibration signature is a system of one or more rolling contact bearings. A rolling contact bearing can include multiple components that can include, for example, one or more of rolling elements, an inner raceway, an outer raceway and a cage. The multiple components of the rolling contact bearing can interact with each other to generate a complex vibration signature.

A vibration signature can depend on multiple factors, including, for example an energy of impact, a measurement location, and a bearing's construction. Frequency analysis of a vibration signature can reveal a base frequency of vibration, and a series of harmonics. Frequency analysis can include Fourier analysis of a time series of accelerometer data, for example. The power spectral density as a function of frequency can be influenced by multiple factors including, for example, a number of rolling elements in a bearing, a loading of the bearing, and a lubrication of the bearing. Typically, the more significant power spectral densities associated with a rolling contact bearing in normal operation are found at frequencies below 1 kHz.

Systems and methods described in the present application include processing measured data at a wireless maintenance sensor prior to its wireless transmission to another sensor or device. Processing measured data at a wireless maintenance sensor can include generating a model of a bearing in operation. In some implementations, the model is a digital model. In some implementations, the model is based at least in part on an energy in one or more frequency bands determined by a frequency analysis of a time series measurement. A digital model based at least in part on an energy in one or more frequency bands is referred to in the present application as a digital energy model.

Processing measured data at a wireless maintenance sensor and generating a digital energy model can provide sufficient data to an HMI of the control system to allow decisions and actions to be taken by an operator and/or maintenance personnel while reducing power consumption and extending a lifetime of the sensor and/or a power source of the sensor.

In some implementations, the sensing element is able to sense a physical parameter such as temperature, pressure, or vibration. In some implementations, the processing elements include Fourier analysis. The sensor can be wirelessly communicably coupled to a wireless zone kit. The wireless zone kit can be an element of a data network and can be communicably coupled to one or more other elements of a data network by a wireless communication channel and/or a wired communication channel. Wireless zone kit 110 can receive data from sensor, including data derived at least in part from a sensed physical parameter.

In some implementations, the wireless zone kit monitors at least one wireless or wired communication channel for requests and/or updates from a control system, which may be a hub of a data network with a star network topology, wherein the wireless zone kit is a host on the data network. Alternatively, the control system and wireless zone kit are nodes in a data network with a mesh network topology.

The sensor can process data sensed, for example, by generating a digital energy model and/or a composite signature of a machine in operation. The sensor can store the digital energy model and/or the composite signature in a data store and classify and/or label the digital energy model and/or the composite signature.

A method of operation of a system for monitoring and controlling a machine is also disclosed. In some implementations, the method comprises the steps of sensing a condition of the bearing by the wireless sensor; generating a model of the bearing, by the wireless sensor, based at least in part on the sensed condition of the bearing; transmitting the model, by the wireless sensor, to the wireless zone kit via a wireless communication channel; comparing the model, by the wireless zone kit, to a reference model stored in the data storage medium; and transmitting a status of the machine, by the wireless zone kit, to the control system.

Further aspects and details of example implementations are set forth in the drawings and following detailed discussion.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements, as drawn, are not necessarily intended to convey any information regarding the actual shape of the particular elements and may have been solely selected for ease of recognition in the drawings.

FIG. 1 is a block diagram of an example implementation of a system that includes a sensor, according to the systems and methods described in the present application.

FIG. 2 is a flowchart illustrating an example implementation of a method of operation of a sensor, according to the systems and methods described in the present application.

FIG. 3 is a flowchart illustrating another example implementation of a method of operation of a system that includes a sensor, according to the systems and methods of the present application.

FIGS. 4A and 4B are parts of a flowchart illustrating another example implementation of a method of operation of a system that includes a sensor, according to the systems and methods of the present application.

FIG. 5 is a flowchart illustrating an example implementation of a method of operation of a sensor for generating a DEM, according to systems and methods of the present application.

FIG. 6A is a schematic plot illustrating an example power spectrum for normal operation of a bearing.

FIG. 6B is a schematic plot illustrating an example representation of a power spectral density for normal operation of a bearing.

FIG. 7A is a schematic plot illustrating an example power spectrum for abnormal of a bearing that would generate a first warning to an operator.

FIG. 7B is a schematic plot illustrating an example representation of a power spectral density for abnormal operation of a bearing that would generate a first warning to an operator.

FIG. 8A is a schematic plot illustrating an example power spectrum for abnormal operation of a bearing that would generate a second warning to an operator.

FIG. 8B is a schematic plot illustrating an example representation of a power spectral density for abnormal operation of a bearing that would generate a second warning to an operator.

FIG. 9A is a schematic plot illustrating an example power spectrum for a bearing that is stopped.

FIG. 9B is a schematic plot illustrating an example representation of a power spectral density for a bearing that is stopped.

FIG. 10A is a schematic plot illustrating an example power spectrum for a bearing at a low RPM.

FIG. 10B is a schematic plot illustrating an example representation of a power spectral density for a bearing at a low RPM.

FIG. 11A is a schematic plot illustrating an example power spectrum for a bearing at a medium RPM.

FIG. 11B is a schematic plot illustrating an example representation of a power spectral density for a bearing at a medium RPM.

FIG. 12A is a schematic plot illustrating an example power spectrum for a bearing at a high RPM.

FIG. 12B is a schematic plot illustrating an example representation of a power spectral density for a bearing at a high RPM.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with industrial machinery and control systems for industrial machinery, including for example bearings, wireless sensors, wireless transceivers, PLCs (Programmable Logic Controllers), and PLC interfaces, and HMIs (Human-Machine Interfaces) have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are synonymous with “include” and variations thereof, and are to be construed in an open, inclusive sense, (i.e., does not exclude additional, unrecited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

Systems and methods described in the present application include processing measured data at a wireless maintenance sensor prior to its wireless transmission to another sensor or device. Processing measured data at a wireless maintenance sensor can include generating a model of a bearing in operation. In some implementations, the model is a digital model. In some implementations, the model is based at least in part on an energy in one or more frequency bands determined by a frequency analysis of a time series measurement. For example, the time series measurement can be based at least in part on data provided by an accelerometer and/or a microphone, alone or in combination. Other suitable measured data can be used alone or in combination with each other and/or with data from an accelerometer and/or a microphone.

A digital model based at least in part on an energy in one or more frequency bands is referred to in the present application as a digital energy model. In some implementations, the digital energy model is a representation of an energy spectral density of signals from one or more sensing elements in a sensor. In other implementations, the digital energy model is a representation of the energy spectral density of signals from one or more sensors. In some implementations, the digital energy model includes a representation of the energy spectral density of at least part of a time series from an accelerometer. In some implementations, the digital energy model includes a representation of the energy spectral density of at least part of a time series from a microphone or other source of audio input. In some implementations, the digital energy model includes a representation of the energy spectral density of at least part of a time series from an accelerometer and at least part of a time series from a microphone or other source of audio input. In some implementations, each time series contributing to the digital energy model undergoes a Fourier transform into the frequency domain. The energy spectral density is computed for each of a number of frequency bands. In some examples, there are four bands for the accelerometer data and one additional band for the microphone, and the five bands are combined to create the digital energy model.

In some implementations, the digital energy model depends on more than one variable. In some implementations, the digital energy model includes time-domain data and frequency-domain data. Time-domain data can include measured data that has not been transformed by a Fourier transform into the frequency domain. Frequency-domain data can include measured data that has been transformed by a Fourier transform into the frequency domain. In example implementations, the digital energy model can include a time series of temperature measurements. In some examples, the temperature measurements are differential temperature measurements. In some examples, time-domain data can be correlated with changes to one or more energy spectral densities in their respective frequency bands. In some examples, the digital energy model can depend at least in part on an RPM of a rotating shaft, and/or can include information about the RPM of the rotating shaft. In some examples, a bandwidth of a frequency band in the digital energy model can vary with the RPM.

In some implementations, processing measured data at a wireless sensor (for example, a wireless maintenance sensor) can include generating a composite signature. A composite signature is a characteristic value or set of values generated by an apparatus (for example, industrial machinery, or a component of industrial machinery such as a bearing) during operation.

Processing measured data at a wireless maintenance sensor can include one or more of sampling a signal, digitizing a sample, performing a filtering operation (for example, an anti-aliasing filtering operation), performing digital filtering, and performing other suitable digital processing operations.

Processing measured data at a wireless maintenance sensor and generating a digital energy model or composite signature can provide sufficient data to an HMI of the control system to allow decisions and actions to be taken by an operator and/or maintenance personnel while reducing power consumption and extending a lifetime of the sensor and/or a power source of the sensor.

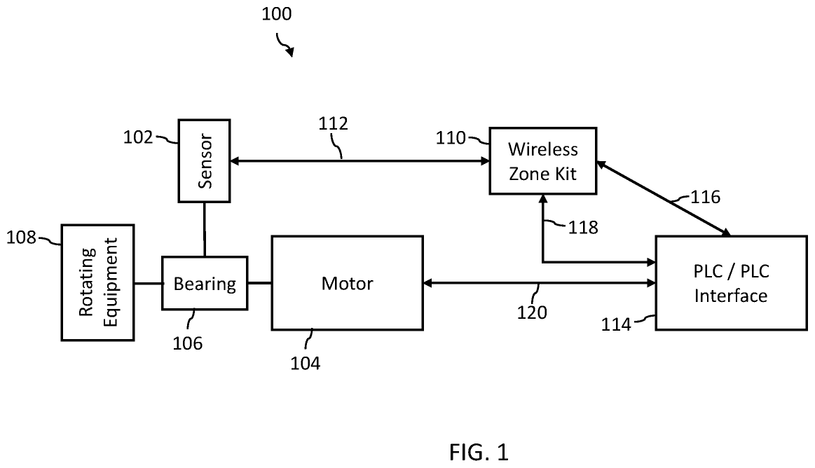

FIG. 1 is a block diagram of an example implementation of a system 100 that includes a sensor 102, according to the systems and methods described in the present application. System 100 includes a motor 104, a bearing 106, and rotating equipment 108. In some implementations, sensor 102 is mounted on bearing 106 or on a housing of bearing 106.

In some implementations, sensor 102 is a wireless sensor. In some implementations, sensor 102 is a wireless maintenance sensor. In some implementations, sensor 102 includes a sensing element, one or more processing elements, a wireless transceiver, and a power source. The wireless transceiver is able to transmit and/or receive data wirelessly. In some implementations, sensing element is able to sense a physical parameter such as temperature, pressure, or vibration. In some implementations, the processing elements include Fourier analysis. In some implementations, the power source includes at least one of a lithium battery and a supercapacitor.

Sensor 102 can be wirelessly communicably coupled to a wireless zone kit 110 via wireless communication channel 112. Wireless zone kit 110 can be an element of a data network. Wireless zone kit 110 can be communicably coupled to one or more other elements of a data network by a wireless communication channel and/or a wired communication channel (not shown in FIG. 1). Wireless zone kit 110 can receive data from sensor 102. Data received by wireless zone kit 110 from sensor 102 can include data derived at least in part from a sensed physical parameter.

In some implementations, wireless zone kit 110 monitors at least one wireless or wired communication channel for requests and/or updates from a control system (not shown in FIG. 1). In some implementations, the control system is a hub of a data network with a star network topology, and wireless zone kit 110 is a host on the data network. In other implementations, the control system and wireless zone kit 110 are nodes in a data network with a mesh network topology.

The wireless sensor can be communicably coupled to a wireless network for communication of data derived from the sensed physical parameter while continuously powered and listening for wireless communication requests and updates from other sensors or devices in a wireless network, for example a wireless network configured as a “mesh” network.

Sensor 102 can include one or more sensing components for sensing one or more physical parameters of an element of system 100 such as bearing 106. For example, sensor 102 can include at least one of an accelerometer, an acoustic sensor, and a thermistor. Data sensed by a sensing component of sensor 102 can be processed by a processing element of sensor 102. Processing can include, for example, generating a digital energy model and/or a composite signature of bearing 106 in operation. Sensor 102 can store the digital energy model and/or the composite signature in a data store. The data store can be an element of sensor 102. Sensor 102 can classify and/or label the digital energy model and/or the composite signature.

In one implementation, sensor 102 is a wireless maintenance sensor that includes a vibration sensor, an acoustic sensor, a thermistor, a processing element, a wireless transceiver, a power source, and a mounting element for mounting sensor 102 on bearing 106. The vibration sensor of sensor 102 can include an accelerometer for sensing vibrational motion associated with bearing 106. In some implementations, sensor 102 collects a time series of measurements from the accelerometer. The time series data may be collected periodically, for example according to a predetermined schedule or at random times. In some implementations, sensor 102 generates a digital energy model and/or composite signature which can be classified, labeled, and/or stored in a data store at sensor 102. In some implementations, the digital energy model and/or composite signature is compared to other stored models and/or signatures.

In some implementations, sensor 102 receives a request from wireless zone kit 110 via wireless communication channel 112. In some implementations, sensor 102 responds to a request from wireless zone kit 110 via wireless communication channel 112 by transmitting a response to wireless zone kit 110 via wireless communication channel 112. In some implementations, sensor 102 sends a digital energy model and/or a composite signature to wireless zone kit 110 via wireless communication channel 112.

System 100 includes a Programmable Logic Controller (PLC) and/or a PLC interface 114. A PLC is a ruggedized and programmable digital computer typically found in industrial environments. A PLC can replace one or more hard-wired relays, timers, and/or sequencers. A PLC is generally a real-time (or quasi-real-time) controller that can generate outputs in response to input conditions in real-time or at least within a limited time. A real-time controller is one that responds to events within a specified time.

PLC/PLC interface 114 is communicably coupled to wireless zone kit 110 via a wireless communication channel 116 and/or a wired communication channel 118. PLC/PLC interface 114 is communicably coupled to motor 104 via communication channel 120. Communication channel 120 is typically a wired communication channel.

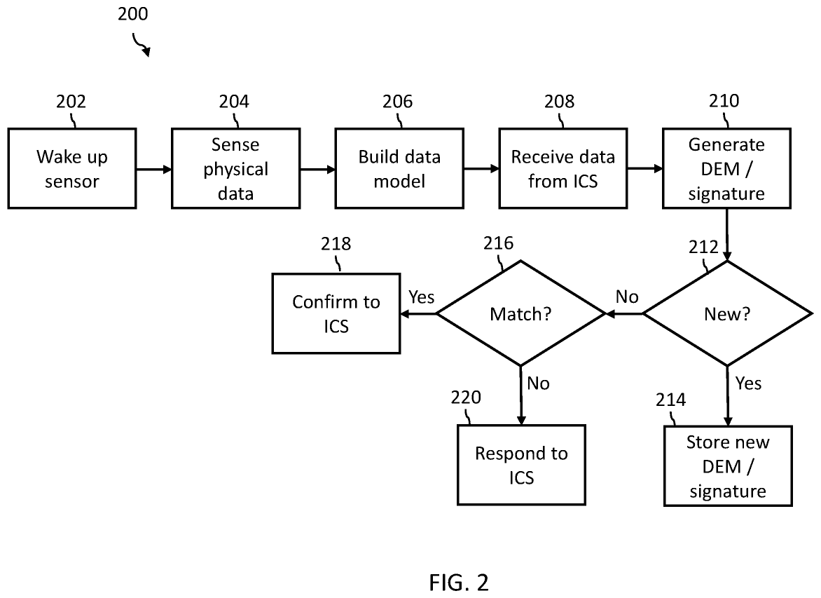

The methods described below with reference to FIGS. 2, 3, 4A, 4B, and 5 may include various acts, though those with skill in the art will appreciate that in alternative examples certain acts may be omitted and/or additional acts may be added, and that the illustrated order of the acts is shown for exemplary purposes only and may change in alternative examples. One or more of the acts of FIGS. 2, 3, 4A, 4B, and 5 are performed by one or more circuits and/or processors (i.e., hardware).

FIG. 2 is a flowchart illustrating an example implementation of a method 200 of operation of a sensor (for example, sensor 102 of FIG. 1), according to the systems and methods described in the present application. Method 200 includes acts 202 to 220.

At 202, the sensor wakes up. For example, the sensor may wake up in response to a command, a trigger, or an expiration of a timer. At 204, the sensor senses physical data. In an example implementation, the sensor records a time series of data from an accelerometer. In another example implementation, the sensor records a temperature or a pressure. In another example implementation, the sensor records an audio signal from a microphone.

At 206, the sensor builds a data model, and, at 208, the sensor receives data from a control system (also referred to in the present application as an Industrial Control System or ICS). At 210, the sensor generates a digital energy model (DEM) and/or a composite signature.

If the DEM is determined at 212 to be a new DEM, then at 214 the sensor stores the new DEM. If the DEM is determined at 212 not to be a new DEM, then at 216 the sensor compares the DEM with one or more DEMs in a data store. If there is a match between the DEM and a DEM in the data store, then the match is confirmed to the ICS at 218. If there is not a match between the DEM and a DEM in the data store, then the sensor responds to the ICS, for example with a null result. It can be determined there is a match between one DEM and another DEM if one or more characteristics of the two DEMs are the same within a specified tolerance. In some implementations, the specified tolerance can be adjusted to vary the closeness of match needed to determine the two DEMs match.

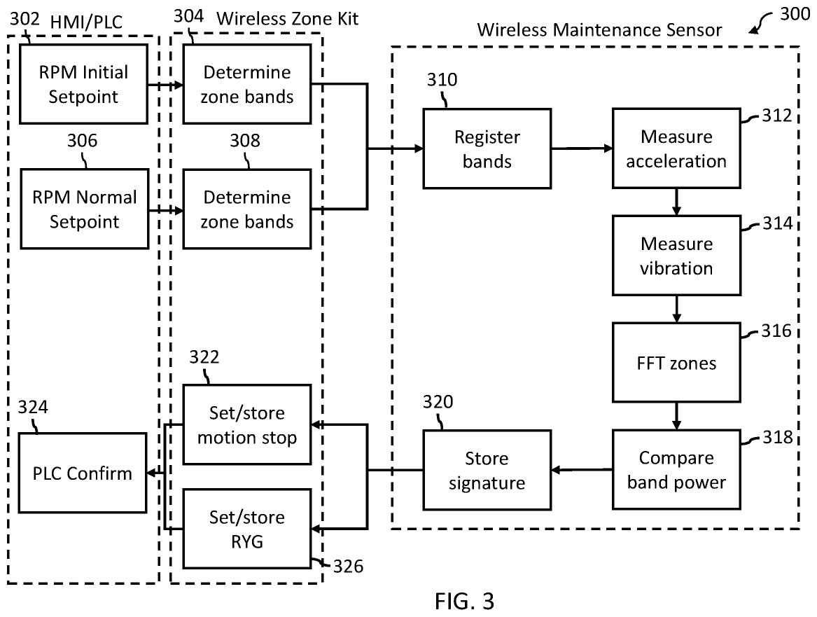

FIG. 3 is a flowchart illustrating an example implementation of another method 300 of operation of a system (such as system 100 of FIG. 1 for example) that includes a sensor (such as sensor 102 of FIG. 1 for example), according to the systems and methods of the present application. In some implementations, method 300 is performed during a calibration procedure, and can be used to generate a DEM corresponding to rotating equipment in the system being motionless, stopped, or at zero RPM.

Method 300 includes acts 302 to 326. As FIG. 3 indicates by the dotted boxes, in some implementations, acts 302, 306, and 324 are performed in an HMI or PLC (such as PLC 114 of FIG. 1 for example), acts 304, 308, 322, and 326 are performed in a wireless zone kit (such as wireless zone kit 110 of FIG. 1 for example), and acts 310, 312, 314, 316, 318, and 320 are performed in a wireless maintenance sensor (such as sensor 102 of FIG. 1 for example).

At 302, the PLC sets an initial RPM (revolutions per minute) setpoint, and at 304 the wireless zone kit determines one or more frequency bands for analysis. In some implementations, the initial RPM can be set by an operator via the HMI, for example. In some implementations, the initial RPM can be set by an automated or semi-automated element of a control system. In some implementations, the frequency bands can be determined by an operator via the HMI, for example. In some implementations, the frequency bands can be determined by an automated or semi-automated element of a control system. The frequency bands can depend on several factors including, for example, an operating RPM.

At 306, the PLC sets a normal setpoint, and at 308 the wireless zone kit determines one or more frequency bands for analysis. In some implementations, the normal setpoint can be set by an operator via the HMI, for example. In some implementations, the normal setpoint can be set by an automated or semi-automated element of a control system. In some implementations, the frequency bands can be determined by an operator via the HMI, for example. In some implementations, the frequency bands can be determined by an automated or semi-automated element of a control system. The frequency bands can depend on several factors including, for example, an operating RPM.

At 310, the wireless maintenance sensor registers the frequency bands. At 312, the wireless maintenance sensor measures an acceleration. In some implementations, the wireless maintenance sensor measures the acceleration using an accelerometer. At 314, the wireless maintenance sensor measures a vibration. The vibration may be a vibration signature. In some implementations, the measured vibration is based at least in part on the measured acceleration. At 316, the wireless maintenance sensor delineates one or more FFT (fast Fourier transform) zones. At 318, the wireless maintenance sensor compares a power in one or more of the frequency bands. At 320, the wireless maintenance sensor stores a DEM and/or composite signature. The DEM and/or composite signature can be generated based at least in part on either the power or the energy in one or more of the frequency bands.

At 322, the wireless zone kit sets or stores a motion stop. At 324, the PLC responds with a confirmation. At 326, the wireless zone kit sets or stores a red/yellow/green value (also referred to in the present application as a RYG value) based at least in part on the DEM or composite signature generated in 318 and 320. In some implementations, the value is on a simple numerical scale (e.g. 1, 2, 3 etc.). In some implementations, the value is an assigned color (e.g. red, yellow, green etc.). For example, a color green can be used to indicate a value indicating normal operation. For example, a color yellow can be used to indicate a value indicating somewhat abnormal operation and/or a first level of alarm. For example, a color red can be used to indicate a value indicating very abnormal operation and/or a second level of alarm. At 324, the PLC confirms the setting or storing of a RYG value. A RYG value can be determined using at least one of empirical, semi-empirical, and analytical data and methods.

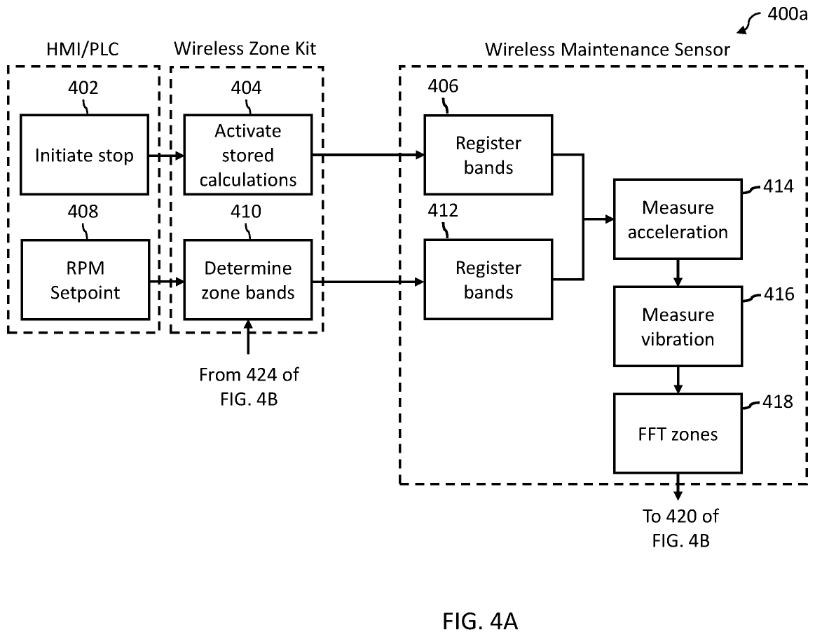

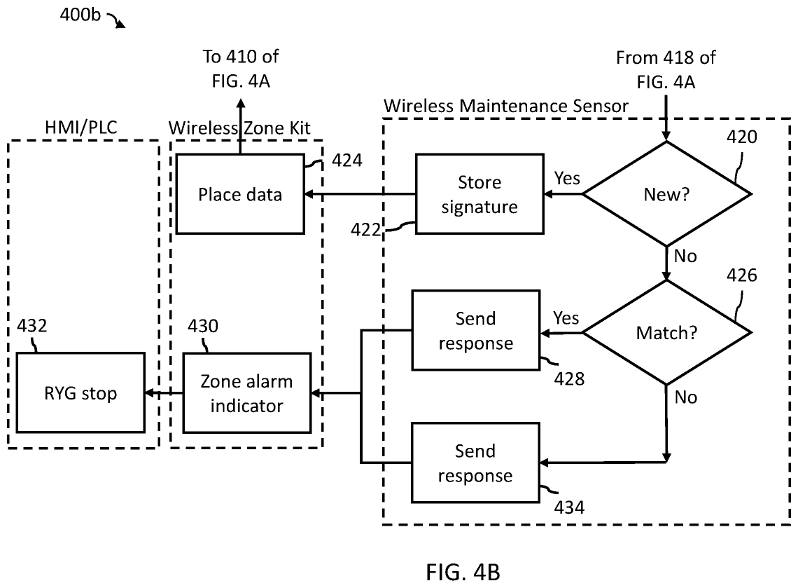

FIGS. 4A and 4B are parts 400a and 400b of a flowchart illustrating an example implementation of another method of operation of a system (such as system 100 of FIG. 1 for example) that includes a sensor (such as sensor 102 of FIG. 1 for example), according to the systems and methods of the present application. In some implementations, parts 400a and 400b are performed during initiation of a stop command by an HMI or PLC. The wireless maintenance sensor generates a DEM, compares it to a stop DEM, and sends a response with the result to the HMI or PLC.

Part 400a includes acts 402 to 418. As FIG. 4A indicates by the dotted boxes, in some implementations, acts 402, and 408 are performed in an HMI or PLC (such as PLC 114 of FIG. 1 for example), acts 404, and 410 are performed in a wireless zone kit (such as wireless zone kit 110 of FIG. 1 for example), and acts 406, and 412 to 418 are performed in a wireless maintenance sensor (such as sensor 102 of FIG. 1 for example).

Part 400b includes acts 420 to 434. As FIG. 4B indicates by the dotted boxes, in some implementations, act 432 is in an HMI or PLC (such as PLC 114 of FIG. 1 for example), acts 424, and 430 are performed in a wireless zone kit (such as wireless zone kit 110 of FIG. 1 for example), and acts 420, 422, 426, 428, and 434 are performed in a wireless maintenance sensor (such as sensor 102 of FIG. 1 for example).

Referring again to part 400a of FIG. 4A, at 402, the PLC initiates a stop of a bearing, and at 404 the wireless zone kit activates one or more stored calculations. The stored calculations can, for example determine one or frequency bands. At 406, the wireless zone kit registers one or more frequency bands. At 408, the PLC sets an RPM setpoint. At 408, the wireless zone kit determines one or more frequency bands for analysis. A wireless zone kit can include, for example, a wireless transceiver (transmitter/receiver), at least one processor, and a storage medium. At 412, the wireless maintenance sensor registers the frequency bands.

At 414, the wireless maintenance sensor measures an acceleration. In some implementations, the wireless maintenance sensor measures the acceleration using an accelerometer. At 416, the wireless maintenance sensor measures a vibration. The measured vibration may be a vibration signature. In some implementations, the measured vibration is based at least in part on the measured acceleration. At 418, the wireless maintenance sensor delineates one or more FFT zones.

Referring again to part 400b of FIG. 4B, if, at 420, the wireless maintenance sensor determines the DEM is new, the wireless maintenance sensor, at 422, stores the DEM. At 424, the wireless zone kit places appropriate data, with respect to band power, and returns to 410 of FIG. 4A.

If, at 420, the wireless maintenance sensor determines the DEM is now new, and, if at 426, the wireless maintenance sensor determines the DEM is a match with a previously stored DEM, the wireless maintenance sensor, at 428, sends a response to the wireless zone kit. At 430, the wireless zone kit triggers a zone alarm indicator. At 432, the HMI/PLC commands a RYG stop. In some implementations, the HMI/PLC commands an end to the current operation of initiating and performing a stop—an operation intended to cause a rotating shaft, for example, to come to a stop.

If, at 426, the wireless maintenance sensor determines the DEM is not a match with a previously stored DEM, the wireless maintenance sensor, at 434, sends a response to the wireless zone kit.

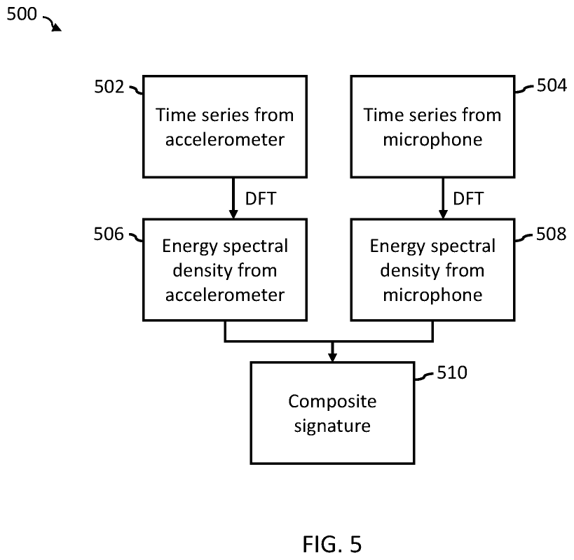

FIG. 5 is a flowchart illustrating an example implementation of a method 500 of operation of a sensor (such as sensor 102 of FIG. 1 for example) for generating a DEM, according to systems and methods of the present application.

At 502, the sensor receives a time series from an accelerometer. At 504, the sensor receives a times series from a microphone. At 506, the sensor transforms at least a portion of the time series from the accelerometer to the frequency domain. In some implementations, the sensor uses a DFT (discrete Fourier transform) to transform at least a portion of the time series from the accelerometer to the frequency domain. In some implementations, the sensor uses an FFT (fast Fourier transform) to transform at least a portion of the time series from the accelerometer to the frequency domain.

At 508, the sensor transforms at least a portion of the time series from the microphone to the frequency domain. In some implementations, the sensor uses a DFT (discrete Fourier transform) to transform at least a portion of the time series from the microphone to the frequency domain. In some implementations, the sensor uses an FFT (fast Fourier transform) to transform at least a portion of the time series from the microphone to the frequency domain.

At 510, the sensor generates a DEM and/or a composite signature based at least in part on an energy spectral density from the accelerometer and/or an energy spectral density from the microphone. In some implementations, the sensor generates a DEM and/or a composite signature based at least in part on a power spectral density from the accelerometer and/or a power spectral density from the microphone.

In some implementations, other data besides vibration data and microphone data can be included in the generation of a DEM. For example, temperature, and in some cases differential temperature, can be included in the generation of a DEM. In some implementations, differential temperature is correlated with frequency analysis, and the result used in the generation of a DEM.

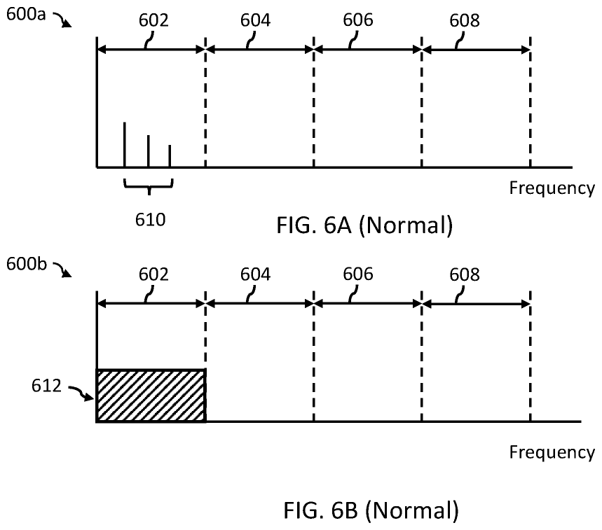

FIG. 6A is a schematic plot illustrating an example power spectrum 600a for normal operation of a bearing. A power spectrum is a distribution of the energy of the time series (such as the time series of accelerometer data) among its frequency components. Power spectrum 600a includes four frequency bands 602, 604, 606, and 608. In other implementations, power spectrum 600a has less than four bands. In other implementations, power spectrum 600a has more than four bands.

In some implementations, frequency bands 602, 604, 606, and 608 have at least approximately equal bandwidth. In some implementations, frequency bands 602, 604, 606, and 608 do not all have at least approximately equal bandwidth. In some implementations, one or more of the bandwidths of frequency bands 602, 604, 606, and 608 can be adjusted. In some implementations, one or more of the bandwidths of frequency bands 602, 604, 606, and 608 can be adjusted in response to data measured by a sensor (for example, sensor 102 of FIG. 1). In some implementations, one or more of the bandwidths of frequency bands 602, 604, 606, and 608 can be adjusted in response to an RPM of a motor or rotating equipment (for example, motor 104 or rotating equipment 108 of FIG. 1).

Power spectrum 600a can include one or more spectral lines 610. Spectral lines 610 can be indicative of a state or a condition of a component (for example, bearing 106 of FIG. 1). In a normal operating state or normal operating condition, spectral lines 610 can include fundamental frequencies and/or harmonics. In the example illustrated in FIGS. 6A and 6B, frequency band 602 includes spectral lines 610 indicative of normal operation. Frequency bands 604, 606, and 608 include no appreciable energy.

FIG. 6B is a schematic plot illustrating an example representation 600b of a power spectral density for normal operation of a bearing. In some implementations, representation 600b is a DEM. Representation 600b includes a DEM value corresponding to the area of shaded region 612 for frequency band 602, and zero DEM values for frequency bands 604, 606, and 608.

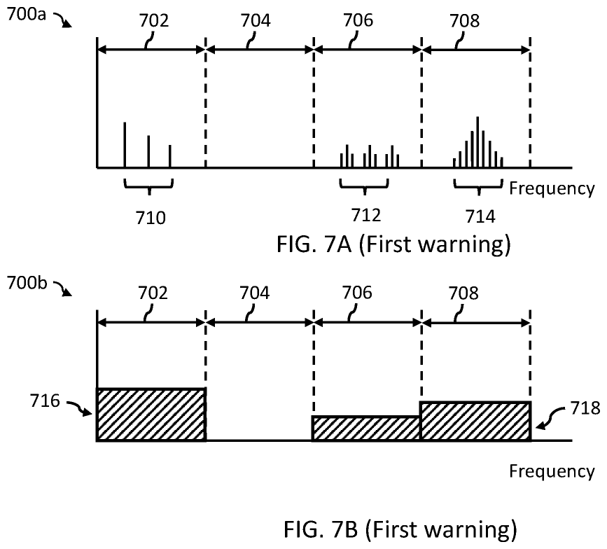

FIG. 7A is a schematic plot illustrating an example power spectrum 700a for abnormal operation of a bearing that would generate a first warning to an operator. A power spectrum is a distribution of the energy of the time series (such as the time series of accelerometer data) among its frequency components. Power spectrum 700a includes four frequency bands 702, 704, 706, and 708. In other implementations, power spectrum 700a has less than four bands. In other implementations, power spectrum 700a has more than four bands.

In some implementations, frequency bands 702, 704, 706, and 708 have at least approximately equal bandwidth. In some implementations, frequency bands 702, 704, 706, and 708 do not all have at least approximately equal bandwidth. In some implementations, one or more of the bandwidths of frequency bands 702, 704, 706, and 708 can be adjusted. In some implementations, one or more of the bandwidths of frequency bands 702, 704, 706, and 708 can be adjusted in response to data measured by a sensor (for example, sensor 102 of FIG. 1). In some implementations, one or more of the bandwidths of frequency bands 702, 704, 706, and 708 can be adjusted in response to an RPM of a motor or rotating equipment (for example, motor 104 or rotating equipment 108 of FIG. 1).

Power spectrum 700a can include one or more spectral lines 710, 712, and 714. Spectral lines 710, 712, and 714 can be indicative of a state or a condition of a component (for example, bearing 106 of FIG. 1). In an abnormal operating state or abnormal operating condition, spectral lines 710, 712, and 714 can include information about the type and degree of abnormality, for example. In the example illustrated in FIGS. 7A and 7B, frequency band 702 includes spectral lines 710 expected to be found in normal operation. Frequency band 704 includes no appreciable energy. Frequency bands 706 and 708 include spectral lines 712 and 714 respectively. Spectral lines 712 and 714 can be indicative of abnormal operation.

FIG. 7B is a schematic plot illustrating an example representation 700b of a power spectral density for abnormal operation of a bearing that would generate a first warning to an operator. In some implementations, representation 700b is a DEM. Representation 700b includes a DEM value corresponding to the area of shaded region 712 for frequency band 702, and a DEM value corresponding to the area of shaded region 718 for each of frequency bands 704, 706, and 708.

In some implementations, representation 700b is wirelessly transmitted to a wireless zone kit (for example wireless zone kit 110 of FIG. 1). In some implementations representation 700b causes an HMI to generate a first warning to an operator. In some implementations, representation 700b causes an HMI to indicate the status of the component (for example, bearing 106 of FIG. 1) using the color yellow.

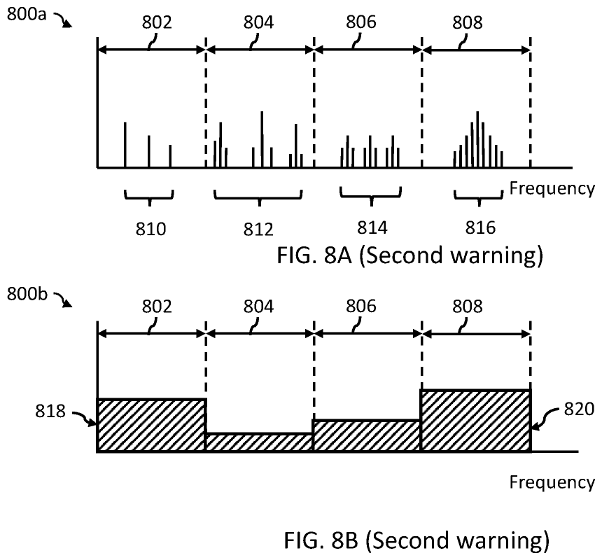

FIG. 8A is a schematic plot illustrating an example power spectrum 800a for abnormal operation of a bearing that would generate a second warning to an operator. A power spectrum is a distribution of the energy of the time series (such as the time series of accelerometer data) among its frequency components. Power spectrum 800a includes four frequency bands 802, 804, 806, and 808. In other implementations, power spectrum 800a has less than four bands. In other implementations, power spectrum 800a has more than four bands.

In some implementations, frequency bands 802, 804, 806, and 808 have at least approximately equal bandwidth. In some implementations, frequency bands 802, 804, 806, and 808 do not all have at least approximately equal bandwidth. In some implementations, one or more of the bandwidths of frequency bands 802, 804, 806, and 808 can be adjusted. In some implementations, one or more of the bandwidths of frequency bands 802, 804, 806, and 808 can be adjusted in response to data measured by a sensor (for example, sensor 102 of FIG. 1). In some implementations, one or more of the bandwidths of frequency bands 802, 804, 806, and 808 can be adjusted in response to an RPM of a motor or rotating equipment (for example, motor 104 or rotating equipment 108 of FIG. 1).

Power spectrum 800a can include one or more spectral lines 810, 812, 814 and 816. Spectral lines 810, 812, 814 and 816 can be indicative of a state or a condition of a component (for example, bearing 106 of FIG. 1). In an abnormal operating state or abnormal operating condition, spectral lines 810, 812, 814 and 816 can include information about the type and degree of abnormality, for example. In the example illustrated in FIGS. 8A and 8B, frequency band 802 includes spectral lines 810 expected to be found in normal operation. Frequency bands 804, 806 and 808 include spectral lines 812, 814 and 816 respectively. Spectral lines 812, 814 and 816 can be indicative of abnormal operation.

FIG. 8B is a schematic plot illustrating an example representation 800b of a power spectral density for abnormal operation of a bearing that would generate a first warning to an operator. In some implementations, representation 800b is a DEM. Representation 800b includes a DEM value corresponding to the area of shaded region 818 for frequency band 802, and a DEM value corresponding to the area of shaded region 820 for each of frequency bands 804, 806, and 808.

In some implementations, representation 800b is wirelessly transmitted to a wireless zone kit (for example wireless zone kit 110 of FIG. 1). In some implementations representation 800b causes an HMI to generate a second warning to an operator. In some implementations, the second warning is a second level of warning, for example a higher level of warning than the first level of warning. In some implementations, representation 800b causes an HMI to indicate the status of the component (for example, bearing 106 of FIG. 1) using the color red.

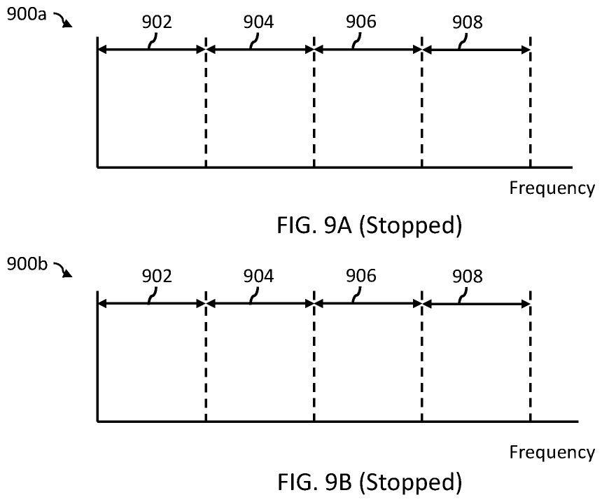

FIG. 9A is a schematic plot illustrating an example power spectrum 900a for a bearing that is stopped. A power spectrum is a distribution of the energy of the time series (such as the time series of accelerometer data) among its frequency components. Power spectrum 900a includes four frequency bands 902, 904, 906, and 908. In other implementations, power spectrum 900a has less than four bands. In other implementations, power spectrum 900a has more than four bands.

In some implementations, frequency bands 902, 904, 906, and 908 have at least approximately equal bandwidth. In some implementations, frequency bands 902, 904, 906, and 908 do not all have at least approximately equal bandwidth. In some implementations, one or more of the bandwidths of frequency bands 902, 904, 906, and 908 can be adjusted. In some implementations, one or more of the bandwidths of frequency bands 902, 904, 906, and 908 can be adjusted in response to data measured by a sensor (for example, sensor 102 of FIG. 1). In some implementations, one or more of the bandwidths of frequency bands 902, 904, 906, and 908 can be adjusted in response to an RPM of a motor or rotating equipment (for example, motor 104 or rotating equipment 108 of FIG. 1). Power spectrum 900a has no appreciable energy in frequency bands 902, 904, 906, and 908.

FIG. 9B is a schematic plot illustrating an example representation 900b of a power spectral density for a bearing that is stopped. In some implementations, representation 900b is a DEM. Representation 900b includes a zero value for each of frequency bands 902, 904, 906, and 908.

In some implementations, representation 900b is wirelessly transmitted to a wireless zone kit (for example wireless zone kit 110 of FIG. 1). In some implementations representation 900b causes an HMI to indicate to an operator that the bearing is stopped.

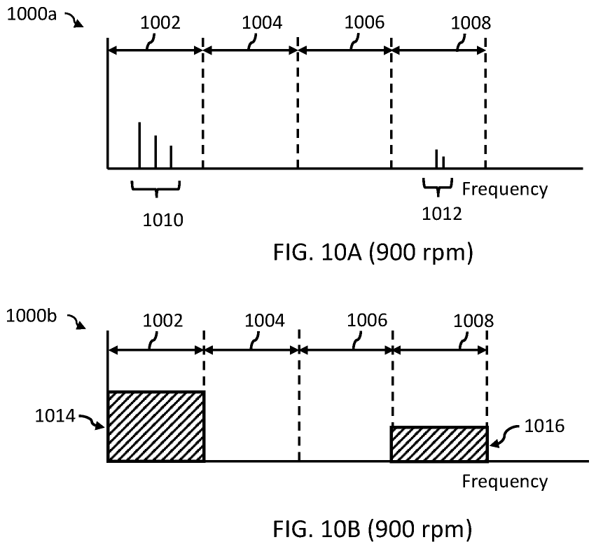

FIG. 10A is a schematic plot illustrating an example power spectrum 1000a for a bearing at a low RPM. In an example implementation, the bearing at low RPM is a bearing at 900 RPM. A power spectrum is a distribution of the energy of the time series (such as the time series of accelerometer data) among its frequency components. Power spectrum 1000a includes four frequency bands 1002, 1004, 1006, and 1008. In other implementations, power spectrum 1000a has less than four bands. In other implementations, power spectrum 1000a has more than four bands.

In some implementations, frequency bands 1002, 1004, 1006, and 1008 have at least approximately equal bandwidth. In some implementations, frequency bands 1002, 1004, 1006, and 1008 do not all have at least approximately equal bandwidth. In some implementations, one or more of the bandwidths of frequency bands 1002, 1004, 1006, and 1008 can be adjusted. In some implementations, one or more of the bandwidths of frequency bands 1002, 1004, 1006, and 1008 can be adjusted in response to data measured by a sensor (for example, sensor 102 of FIG. 1). In some implementations, one or more of the bandwidths of frequency bands 1002, 1004, 1006, and 1008 can be adjusted in response to an RPM of a motor or rotating equipment (for example, motor 104 or rotating equipment 108 of FIG. 1). Power spectrum 1000a has spectral lines 1010 in frequency band 1002 and spectral lines 1012 in frequency band 1008. Power spectrum 1000a has no appreciable energy in frequency bands 1004 and 1006.

FIG. 10B is a schematic plot illustrating an example representation 1000b of a power spectral density for a bearing at a low RPM. In an example implementation, the bearing at low RPM is a bearing at 900 RPM. In some implementations, representation 1000b is a DEM. Representation 1000b includes a DEM value corresponding to the area of shaded region 1014 for frequency band 1002 and a DEM value corresponding to the area of shaded region 1016 for each of frequency bands 1004, 1006, and 1008. In some implementations, representation 1000b is wirelessly transmitted to a wireless zone kit (for example wireless zone kit 110 of FIG. 1).

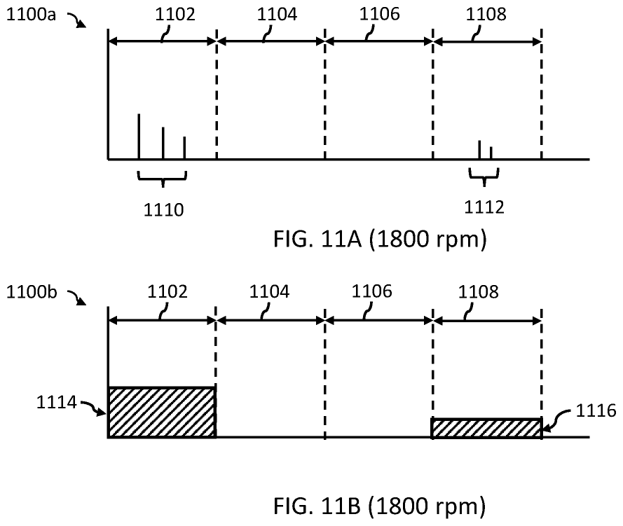

FIG. 11A is a schematic plot illustrating an example power spectrum 1100a for a bearing at a medium RPM. In an example implementation, the bearing at medium RPM is a bearing at 1800 RPM. A power spectrum is a distribution of the energy of the time series (such as the time series of accelerometer data) among its frequency components. Power spectrum 1100a includes four frequency bands 1102, 1104, 1106, and 1108. In other implementations, power spectrum 1100a has less than four bands. In other implementations, power spectrum 1100a has more than four bands.

In some implementations, frequency bands 1102, 1104, 1106, and 1108 have at least approximately equal bandwidth. In some implementations, frequency bands 1102, 1104, 1106, and 1108 do not all have at least approximately equal bandwidth. In some implementations, one or more of the bandwidths of frequency bands 1102, 1104, 1106, and 1108 can be adjusted. In some implementations, one or more of the bandwidths of frequency bands 1102, 1104, 1106, and 1108 can be adjusted in response to data measured by a sensor (for example, sensor 102 of FIG. 1). In some implementations, one or more of the bandwidths of frequency bands 1102, 1104, 1106, and 1108 can be adjusted in response to an RPM of a motor or rotating equipment (for example, motor 104 or rotating equipment 108 of FIG. 1). Power spectrum 1100a has spectral lines 1110 in frequency band 1102 and spectral lines 1112 in frequency band 1108. Power spectrum 1100a has no appreciable energy in frequency bands 1104 and 1106.

FIG. 11B is a schematic plot illustrating an example representation 1100b of a power spectral density for a bearing at a medium RPM. In an example implementation, the bearing at medium RPM is a bearing at 1800 RPM. In some implementations, representation 1100b is a DEM. Representation 1100b includes a DEM value corresponding to the area of shaded region 1114 for frequency band 1102 and a DEM value corresponding to the area of shaded region 1116 for each of frequency bands 1104, 1106, and 1108. In some situations, the DEM values corresponding to the areas of shaded regions 1114 and 1116 can be at least approximately the same as the DEM values corresponding to the areas of shaded regions 1014 and 1016. That is, in some situations, DEM values can be at least approximately invariant with respect to RPM. In some implementations, representation 1100b is wirelessly transmitted to a wireless zone kit (for example wireless zone kit 110 of FIG. 1).

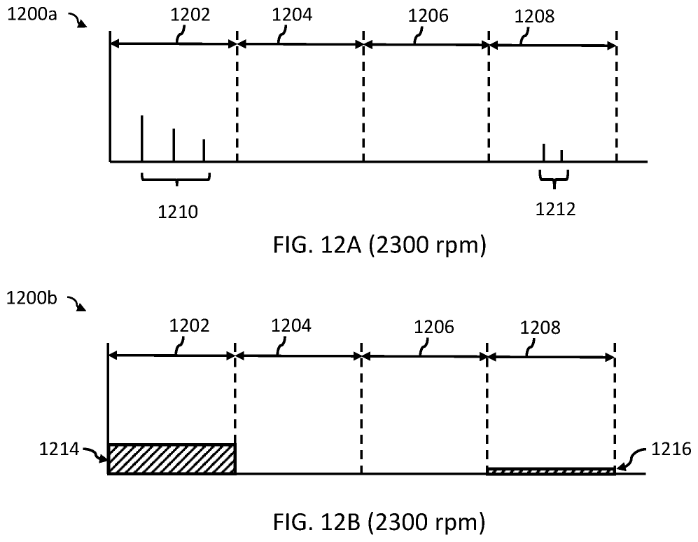

FIG. 12A is a schematic plot illustrating an example power spectrum 1200a for a bearing at a high RPM. In an example implementation, the bearing at high RPM is a bearing at 2300 RPM. A power spectrum is a distribution of the energy of the time series (such as the time series of accelerometer data) among its frequency components. Power spectrum 1200a includes four frequency bands 1202, 1204, 1206, and 1208. In other implementations, power spectrum 1200a has less than four bands. In other implementations, power spectrum 1200a has more than four bands.

In some implementations, frequency bands 1202, 1204, 1206, and 1208 have at least approximately equal bandwidth. In some implementations, frequency bands 1202, 1204, 1206, and 1208 do not all have at least approximately equal bandwidth. In some implementations, one or more of the bandwidths of frequency bands 1202, 1204, 1206, and 1208 can be adjusted. In some implementations, one or more of the bandwidths of frequency bands 1202, 1204, 1206, and 1208 can be adjusted in response to data measured by a sensor (for example, sensor 102 of FIG. 1). In some implementations, one or more of the bandwidths of frequency bands 1202, 1204, 1206, and 1208 can be adjusted in response to an RPM of a motor or rotating equipment (for example, motor 104 or rotating equipment 108 of FIG. 1). Power spectrum 1200a has spectral lines 1210 in frequency band 1202 and spectral lines 1212 in frequency band 1208. Power spectrum 1200a has no appreciable energy in frequency bands 1204 and 1206.

FIG. 12B is a schematic plot illustrating an example representation 1200b of a power spectral density for a bearing at a high RPM. In an example implementation, the bearing at high RPM is a bearing at 2300 RPM. In some implementations, representation 1200b is a DEM. Representation 1200b includes a DEM value corresponding to the area of shaded region 1214 for frequency band 1202 and a DEM value corresponding to the area of shaded region 1216 for each of frequency bands 1204, 1206, and 1208. In some situations, the DEM values corresponding to the areas of shaded regions 1214 and 1216 can be at least approximately the same as the DEM values corresponding to the areas of shaded regions 1014 and 1016, and the DEM values corresponding to the areas of shaded regions 1114 and 1116. That is, in some situations, DEM values can be invariant with respect to RPM. In some implementations, representation 1200b is wirelessly transmitted to a wireless zone kit (for example wireless zone kit 110 of FIG. 1).

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). In another implementation, the present subject matter may be implemented via embedded software and/or firmware and microcontrollers. Those of skill in the art will recognize that many of the methods set out herein may employ additional acts, may omit some acts, and/or may execute acts in a different order than specified.

The various implementations described above can be combined to provide further implementations. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

The various embodiments and implementations described above can be combined to provide further embodiments and implementations.

What is claimed is:

1. A system for monitoring a machine, the system comprising:
a wireless sensor coupled to the machine;
a wireless zone kit comprising a wireless transceiver and a processor, wherein the wireless zone kit is wirelessly communicatively coupled to the wireless sensor; and
a controller communicatively coupled to the wireless zone kit, the controller also being communicatively coupled to the machine, wherein, in operation, the wireless sensor generates a digital energy model, based on data measured by the sensor, and transmits the digital energy model to the wireless zone kit, whereupon the wireless zone kit transmits the digital energy model to the controller.

2. The system of claim 1 wherein the machine comprises:
a motor;
a bearing coupled to the motor;
a housing of the bearing coupled to the bearing; and
rotating equipment coupled to the bearing, wherein the wireless sensor is coupled to the housing of the bearing.

3. The system of claim 1 wherein the wireless sensor is at least one of an accelerometer, a microphone, and a thermistor.

4. The system of claim 1 wherein the controller is a Programmable Logic Controller (PLC).

5. The system of claim 1 wherein the controller includes a human-machine interface (HMI) which, in operation, displays a status of the machine to an operator, wherein the status is determined by the controller based on the digital energy model received from the wireless zone kit.

6. A method of operation of a system for monitoring and controlling a machine, the machine comprising a motor, a bearing, a housing of the bearing, and rotating equipment, the system comprising a wireless sensor mounted on the housing of the bearing, a wireless zone kit comprising a wireless
transceiver, a processor, and a data storage medium, and a control system comprising a human-machine interface (HMI), the method comprising:
sensing a condition of the bearing by the wireless sensor;
generating a model of the bearing, by the wireless sensor, based at least in part on the sensed condition of the bearing;
transmitting the model, by the wireless sensor, to the wireless zone kit via a wireless communication channel;
comparing the model, by the wireless zone kit, to a reference model stored in the data storage medium; and
transmitting a status of the machine, by the wireless zone kit, to the control system.

7. The method of claim 6 further comprising displaying the status of the machine on the HMI of the control system.

8. The method of claim 7 wherein sensing a condition of the bearing includes measuring a motion of the housing of the bearing by the wireless sensor.

9. The method of claim 8 wherein measuring a motion of the housing of the bearing by the wireless sensor includes measuring at least one of a displacement, a velocity, and an acceleration of the housing.

10. The method of claim 8 wherein measuring a motion of the housing of the bearing by the wireless sensor includes measuring at least one of a time series from an accelerometer in the wireless sensor and a time series from a microphone in the wireless sensor.

11. The method of claim 10 wherein generating a model of the bearing, based at least in part on the sensed condition of the bearing, includes:
defining a plurality of frequency bands;
determining, for each of the plurality of frequency bands, a respective energy spectral density; and
converting the respective energy spectral density to a numerical scale.

12. The method of claim 11 wherein determining, for each of the plurality of frequency bands, a respective energy spectral density includes performing a frequency analysis of at least one of the time series from the accelerometer and the time series from the microphone.

13. The method of claim 12 wherein performing a frequency analysis of at least one of the time series from the accelerometer and the time series from the microphone includes performing at least one Fourier transform.

14. The method of claim 11 wherein converting the respective energy density to a numerical scale includes converting the respective energy spectral density to a color representation.

15. The method of claim 6 further comprising receiving an RPM of the motor, wherein generating a model of the bearing includes generating a model of the bearing that depends at least in part on the RPM of the motor.
